(19) United States
(12) Patent Application Publication
(10) Pub. No.: US 2015/0192108 A1
(43) Pub. Date: Jul. 9, 2015

(54) Internal Pressure Reduction Mechanism for an Open Turbine Used for Power Production

(71) Applicant: SequestraPower, Ltd, Bedford (GB)

(72) Inventor: Kevin Alexander Paul Kirchman, Bedford (GB)

(73) Assignee: SequestraPower,Ltd, Bedford (GB)

(21) Appl. No.: 14/664,896

(22) Filed: Mar. 22, 2015

Related U.S. Application Data
(60) Provisional application No. 61/968,391, filed on Mar. 21, 2014.

(51) Int. Cl. F03D 9/00; F03D 3/06; F03D 3/00

(52) U.S. Cl. CPC F03D 9/001; F03D 3/005; F03D 3/061

(57) ABSTRACT

A device for reducing the internal pressure between the turbine blades of a transverse axis or fluid-flow-aligned axis, power-producing turbine, such as a wind turbine, by exhausting fluid out the top or bottom of the unit using a mechanical fan or pump. A moving fluid, such as air, can be forced through a conduit, as in FIG. 1 within the Tower 108, by a mechanical fan 102, for further processing to remove valuable constituents, such as carbon dioxide for use in zero-carbon fuel production, or rare gas harvesting. As there is a necessary energy cost for moving the fluid in such applications, the device improves the overall efficiency. This has the effect of increasing the power conversion efficiency past the Betz' Limit for turbines that harvest renewable energy and collect chemical constituents of air.

### CROSS-REFERENCE TO RELATED APPLICATIONS

This application claims the benefit of U.S. Provisional Patent Application 61/968,391, filed on Mar. 21, 2014 by the present inventor.

### FIELD OF THE INVENTION

This invention relates to turbine design for energy harvesting and in particular the efficiency improvement of open turbines.

### BACKGROUND OF THE INVENTION

Challenges of over-utilization of natural resources, specifically hydrocarbon fuels, have been at the fore of issues causing concern in society. As a result, greater numbers of people and businesses have turned to renewable energy—solar, wind, wave, and tidal power—to get the energy that is a critical part of their lives and operations.

As a result, in the past few decades wind turbine production has become a large industry and tidal energy production from water-based turbines have secured hundreds of millions of investment.

The present invention provides a way to overcome a problem which was heretofore considered unsolvable—that of exceed natural limitations to the amount of energy that can be harvested by wind or water turbines.

Wind and tidal stream turbines are limited in their capacity to harvest energy from the fluid flowing past them according to Betz' Law, published by Albert Betz in 1919, which has subsequently been validated by computational fluid dynamic models and demonstrations.

The concept of the Betz' Law is that as energy is taken from a flow field by an energy harvesting device, the energy loss is manifest in a slower velocity of flow through the device, because of conservation of energy. This slower flow causes flow that is upstream of the device to divert around the device. As a consequence of flow diversion, less flow goes through the device, and therefore less energy can be harvested.

It is concluded in the art that the limit of energy that is possible to be harvested from a flow field as established by Betz' Law cannot be exceeded. Thus the industry concedes this limit, and all standards are built around it, as if it could never be overcome by a new device. Manufacturers commonly compare their turbines' performance to the Betz Limit, which holds that no more than 16/27 (59.3%) of the kinetic energy of the wind can be converted into mechanical energy turning a rotor.

Thus a device that made it possible to overcome this limitation would have substantial commercial value, by improving the possible performance of energy-producing turbines of which it formed a part.

### PRIOR ART

The prior art does not provide any technologies that are similar to the present embodiment. Somewhat related art includes numerous patents on wind turbine design, some of which are:

In Neil GB2477509, the inventor discloses a device for affecting the flow of air around an airfoil in a VAWT, but this does not influence the effect of Betz' Law.

In Cyrus et al U.S. Pat. No. 4,504,192, the inventor discloses a device for affecting the flow of air around an airfoil in a VAWT, but this invention also does not influence the effect of Betz' Law.

### BRIEF SUMMARY OF THE INVENTION

One advantage of an aspect of the present invention is to provide a means of reducing the internal pressure of an open turbine in fluid flow in the face of oncoming fluid, with the effect that less fluid goes around the turbine, going instead through it, thus counteracting the problem characterized by Betz' Law. This is accomplished with a mechanical pump or fan pushing or pulling fluid out of the area between the blades, or into a conduit to be transferred for other purposes.

Yet another advantage of an aspect of the present invention is a provision which serves to distribute numerous pressure sinks to accomplish the prior advantage so as to not further contribute to turbulence which degrades the flow impinging upon the blades in the downstream side of a turbine (for a transverse-axis type turbine), by spacing fluid inlets effectively through the structure of the turbine, supports, and central axis.

A third advantage of an aspect of the present invention is as a result of its use the creation of a lower pressure region around the central axis of a transverse-axis turbine, thereby reducing its shielding and turbulence inducing effect on the downwind blades.

A fourth advantage of an aspect of the present invention is to provide a means of forcefully directing large amounts of air, gas or liquid that can be scrubbed of CO₂, water vapor or other gases or chemical constituents for collection and use or sale. This can occur by using conduits formed within the structure of an open turbine.

The device and apparatuses can be fabricated from metal, wood, plastic, composite, or other materials as is known in the art.

### DETAILED DESCRIPTION OF THE INVENTION

The present invention seeks to overcome the Betz Limit by modifying the pressure field around a spinning transverse-axis or horizontal-axis turbine by inserting an aerodynamic sink into its center, which is a region that has lower pressure than its surroundings because fluid is removed. This changes how the turbine ‘appears’ to oncoming flow, thus allowing greater flow to pass through the turbine, consequently increasing the energy available for harvesting, which has the effect of improving the efficiency of an open turbine.

The term “Tranverse-axis Turbines”, as used in the art, can refer to Vertical-Axis Wind Turbines (VAWTs), or water or turbines which are tilted at an angle from vertical, or other fluid turbines where the axis is across the flow. “Fluid-flow-aligned Axis Turbines” refer to Horizontal-Axis Wind Turbines (HAWTs), or water or other fluid turbines where the axis is aligned with the flow of fluid.

Using a mechanical fan or pump mounted internally within the turbine axis or tower, or alternatively externally at some point along the axis or tower, causes the air to move along the axis and out one or both ends of the turbine, reducing the pressure within the turbine swept volume.

The mechanical fan or fluid pump must be powered and thus consumes energy to counteract the advantage of the invention. The invention has economic value for new applications of power-producing turbines because substantial amounts of fluid must be moved in order to harvest chemicals from the passing fluid, as in the case of harvesting carbon dioxide, water vapor or other constituent gases from air. Carbon dioxide and water vapor have particular value as they can be used as feed gases to reactions that form hydrocarbons, for instance hydrocarbon fuels that can store energy harvested by wind turbines. Commercially valuable gases such as argon might additionally be harvested using only renewable energy.

A first embodiment of the invention is its use within a transverse-axis turbine, also called a vertical-axis turbine when the transverse axis is vertical. An example of this embodiment is shown in FIG. 1, a perspective view of a vertical-axis wind turbine (VAWT). Here, Blades 112 are supported by Struts 110 that surround a Tower 108 along a central axis of a Vertical Axis Wind Turbine 100.

Air Inlets 106 are distributed around the Tower 108 in this embodiment, but could also be distributed in Struts 110 or Blades 112. The Air Inlets pass air into Conduits 116, where it can be transferred for further chemical processing, for instance.

The Air Inlets 106 could be round, rectangular, or any other shape that facilitated effective air transfer and/or lessened drag and turbulence in the turbine. They could additionally be large or small, of any size. One method inlet distribution can be accomplished is through the use of computational fluid dynamics calculations and algorithms, reiterating through various inlet shapes, sizes, and placements so as to reduce overall downstream drag, as well as drag on the structures individually.

The embodiment in FIG. 1 shows both Air Inlets 106 and a Mechanical Fan 102, which could in another embodiment be one or the other, rather than both. The Mechanical Fan 102 could be placed at the top of the Tower 108, at the bottom, or both. It could also be replaced by a Propeller 202, as in FIG. 2, which is a mechanical fan located outside of the tower around the Central Rotating Axis 204.

Another form of the embodiment could be manufactured similarly around a fluid-flow-aligned-axis turbine (also known as a horizontal-axis turbine), where air inlets were distributed around a nacelle where air, gas or liquid could be withdrawn, or within the blades of a turbine, including the ends, where air, gas or liquid could exhaust.

The invention functions by moving the air from the lower pressure regions 104 or 210 in the figures, either out of the regions, or into the tower, where it can be further processed to remove chemical constituents from the flowing fluid.

The device can be powered either by directly connecting a mechanical fan or pump to a rotating open turbine, such as a wind or tidal turbine, or via hydraulic, electric, or other power provided by the same turbine or from an auxiliary energy source. The mechanical fan or pump could be turned either in the same direction as the rotating turbine blades, or the opposite.

The invention might also be used by a horizontal-axis wind turbine (HAWT) by placing a blower inlet on the front or sides of a nacelle, for instance. Alternatively it might be installed on an HAWT by incorporating inlets on turbine blades, along leading or trailing edges, or at the ends.

Air produced by the effect of the blower or propeller can be forced by ducting through an air capture device, for instance one incorporating chemicals such as NaOH for scrubbing CO₂, or utilizing another invention disclosed by the same author for harvesting water vapor from flowing air, or using a cryogenic device for distillation of rare gases.

### BRIEF DESCRIPTION OF THE DRAWINGS

The invention is herein described, as through example only, with reference to the accompanying drawings, wherein:

FIG. 1 shows one embodiment of the invention, where a blower or axial fan is integrated with a vertical-axis turbine tower, which also has perforations along it through which air passes, forced by the axial fan in order to more evenly distribute the sink along the entire center of the apparatus.

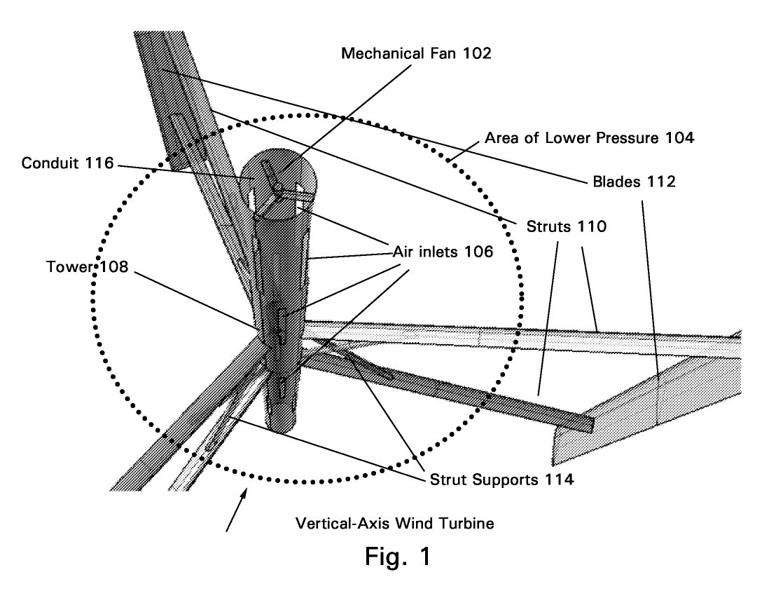

FIG. 2 is a diagram showing the basic idea of the invention in exhausting air from the center of the wind turbine using a propeller form of a mechanical fan.

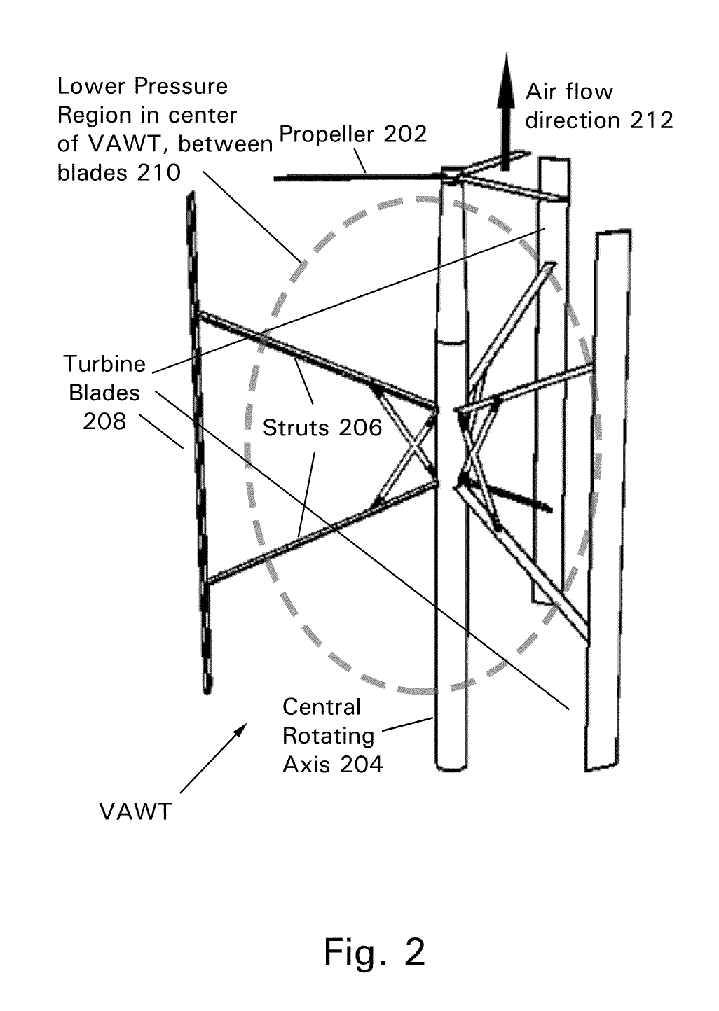

FIG. 3 is a diagram of a flow field around a transverse-axis turbine, shown from the axial view of the turbine, which shows the flow in prior-art turbines, and how it is diverted in the front of the turbine around the turbine.

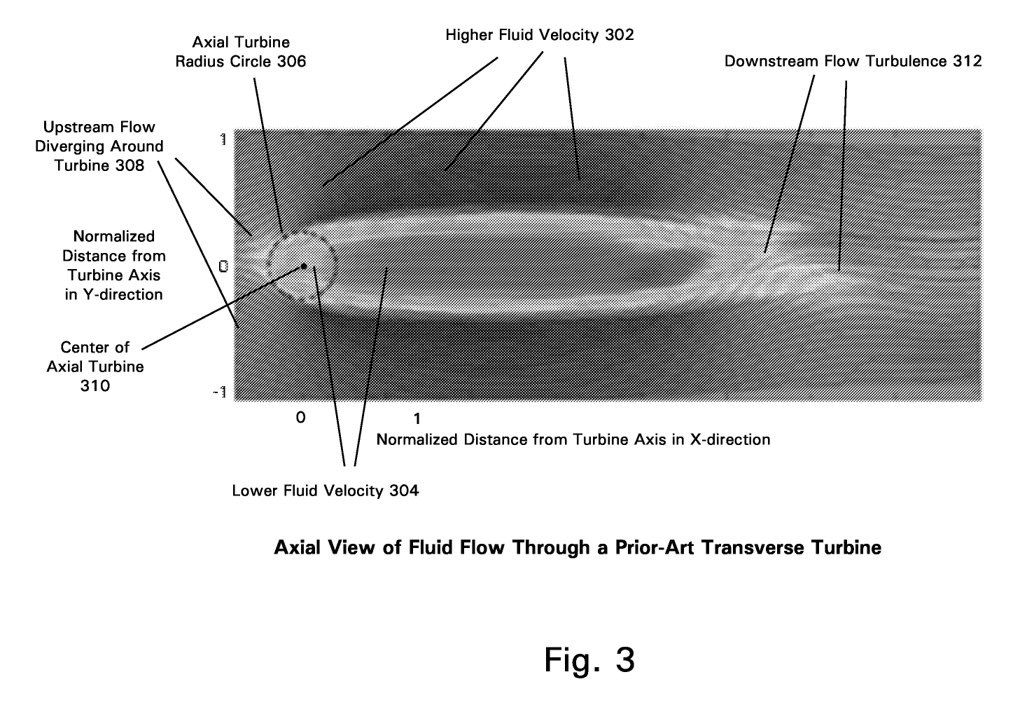

### CONCLUSIONS, RAMIFICATIONS AND SCOPE

Thus the reader can see the invention provides a means of increasing the possible energy harvested from a rotating open turbine, which after the normal mechanical and electrical inefficiencies are removed, leaves a greater power output. Because turbines can produce energy that can be stored by hydrocarbon fuels, one application of the device is to collect carbon dioxide from air which can be converted into fuel using the renewable energy that is produced, thus ultimately producing carbon-neutral hydrocarbon fuel.

The invention thus makes it possible to use a wind turbine to produce zero-carbon fuel more efficiently and cost effectively, as the cost of incorporating the device into a turbine is very low compared to the cost of the turbine.

Other significant uses would be the purely renewable-powered collection of rare but valuable industrial gases such as argon, krypton, neon, and xenon, which rely upon the movements of large amounts of air for their production. Water vapor might be also be collected from air in arid regions solely using renewable energy, and converted into water for human consumption and industrial use.

The device can be used in both transverse-axis as well as fluid-flow-aligned-axis turbines functioning in both water and air, or in extra-terrestrial environments which have atmospheres where it might be advantageous to collect valuable gases without requiring the provision of external fuel.

While the above description contains many specific details, these should not be construed as limitations on the scope, but rather as an exemplification of one or several embodiments thereof. Many other variations are possible.

Accordingly, the scope should be determined not be the embodiment illustrated, but by the appended claims and their legal equivalents.

What is claimed is:

1. A device comprising:
A Transverse-Axis or Fluid-flow-aligned Axis Turbine for energy production in a fluid flow field;
One or more Mechanical Fans or Pumps oriented or established so as to provide a means of exhausting fluid from a flow field along the axis of said Transverse-Axis or Fluid-flow-aligned Axis Turbine to a region outside of the general region enclosed by said turbine, thereby creating a region of pressure lower than the ambient pressure.

2. The device of claim 1 that includes:
A set one or more Perforations through which fluid in a flow field is forced by said Mechanical Fans or Pumps, said Perforations located within the Structure of the Turbine, Supports, Blades and Central Axis of said Transverse-Axis or Fluid-flow-aligned Axis Turbine and thereby directing fluid in a flow field into
One or more Conduits which provides a means of transferring the fluid outside of the center region of said Transverse-Axis or Fluid-flow-aligned Axis Turbine.

3. The device of claim 2 that includes said Perforations located in such a manner, equidistant or in aerodynamically advantageous places, as one would do familiar with the art of the use of CFD (Computational Fluid Dynamics) numerical analysis or software for design, so as to reduce the turbulence they induce.

4. The device of claims 1-3 where said Mechanical Fans or Pumps are placed along the axis of said Transverse-Axis or Fluid-flow-aligned Axis Turbine directing fluid into said Structure of the Turbine, Supports, Blades and Central Axis through said Conduits directed outwards.

5. The device of claim 4 where the fluid is directed via said Conduits through a Chemical Collection or Conversion Device for separating and storing chemical constituents of the fluid.

6. The device of claim 5 where the Chemical Collection or Conversion Device is a CO2 adsorbent system that removes the CO2 from the air.

7. The device of claim 5 where the Chemical Collection or Conversion Device is a Water Vapor Collection system.

8. The device of claim 5 where the Chemical Collection or Conversion Device is a Gas Collection System utilizing cryogenic distillation.
